(19) United States
(12) Patent Application Publication
(10) Pub. No.: US 2006/0024448 A1
(43) Pub. Date: Feb. 2, 2006

(54) Method of producing laminate body having thin metal layer

(76) Inventor: Yasuhiro Mori, Tokyo (JP)

Correspondence Address: Mori Yasuhiro, 3-12-1 Kiba, Koto-ku, 135-0042, JP

(21) Appl. No.: 11/193,507

(22) Filed: Aug. 1, 2005

(30) Foreign Application Priority Data
Aug. 2, 2004 (JP) JP2004-225407

(51) Int. Cl. B05D 1/08; C23C 4/00

(52) U.S. Cl. 427/446

(57) ABSTRACT

A method of producing a laminate body having a thin metal layer on a substrate including processes (1) to (4) as follows: (1) preparing the substrate; (2) blowing a flame in which a silicon containing compound is introduced; (3) forming an undercoating layer by coating with a lacquer or a primer; and (4) forming a thin metal layer by reducing a metal ion. In addition, process (5), in which a topcoating layer is formed on the metal layer is preferably included in the present invention. The present invention makes it possible to coat various substrates with the metal layer (silver mirror). Practically all kinds of substrate may be used as a substrate to be coated.

### FIELD OF THE INVENTION

The present invention relates to a method of producing a laminate body having a thin metal layer on a substrate, especially to a method of producing a laminate body having a silver mirror layer.

### BACKGROUND OF THE INVENTION

Plating has been used for metallic coating. However some poisonous metal such as chromate, or hazardous compound such as KCN must be used in plating. Recently silver mirror reaction is used for metallic coating instead of plating, because of no use of dangerous chemicals.

Usually, silver mirror is formed on a substrate as follows:
1) preparing a substrate;
2) modifying a surface of the substrate;
3) coating a primer layer;
4) coating an undercoating layer with a conventional lacquer (heat-curable);
5) treating a surface of the undercoating layer with a solution containing a catalyst;
6) spraying a solution containing Ag⁺ and a solution containing a reducing agent at same time to form a silver layer on the undercoating layer; and
7) coating a topcoating layer with a conventional lacquer (heat-curable).

### PROBLEMS TO BE RESOLVED BY THE INVENTION

In this way, a metal layer to be formed by the silver mirror reaction needs these relatively complex processes. The complex processes require longer time and higher cost. Defects are often found because of difficulty in perfect operation of the complex processes.

An objective of the present invention is to reduce a time and cost for a metallic coating such as a silver mirror coating.

### SUMMARY OF THE INVENTION

The present invention offers a method of producing a laminate body having a thin metal layer on a substrate including processes (1) to (4) as follows:
(1) preparing the substrate (SUBSTRATE PREPARATION);
(2) blowing a flame in which a silicon containing compound is introduced (SURFACE MODIFICATION);
(3) forming an undercoating layer by coating with a lacquer or a primer (UNDERCOATING); and
(4) forming a thin metal layer by reducing a metal ion (METAL LAYER FORMATION).

In addition, process (5), in which a topcoating layer is formed on the thin metal layer (TOPCOATING), is preferably included in the present invention.

The thin metal layer formed by the method mentioned above is preferably 0.01 μm to 10 μm in thickness.

The thin metal layer preferably contains any one of metals selected from a group of Au, Ag, Cu, Ni and Al as a main element.

The flame is blown for a period from 0.1 sec to 100 sec per 100 cm².

The lacquer for the undercoating is preferably an UV-curable lacquer.

The lacquer for the topcoating is preferably an UV-curable lacquer.

The thin metal layer is formed as a part of amusements (pachinko), electrical products, vehicles (Car), instruments (machines), tools, furniture, or ornaments.

### BRIEF DESCRIPTION OF THE DRAWINGS

FIG. 1 in an illustration of a device of the surface treatment of the present invention (ITRO treatment machine (trademark of ISIMAT-JAPAN.Ltd.)).

### DESCRIPTION OF THE PREFERRED EMBODIMENTS

(1) Substrate Preparation

Conventionally, it was difficult to form an undercoating layer for the thin metal layer on various substrates except for ABS resin.

However, the surface modification, carried out in process (2) of the present invention as mentioned above, makes it possible to coat various substrates with an undercoating layer. Practically all kinds of substrate may be used as a substrate to be coated. Glass, ceramics, metals such as iron, stainless (SUS), copper, magnesium, and aluminum, plastics including polyolefins such as polypropylene, polyethylene, polycarbonate, Acrylonitrile-Butadien-Styrene (ABS) resin, polystyrene, polyurethanes, polyamids, polyethylene terephthalate, polyacrylates, polymethcrylates, polyurea, polyimides, various kinds of engineering plastics, for example, may be used as a substrate. Also, the combination of these materials may be used as a substrate.

(2) Surface Modification

In the present invention, the surface of a substrate is modified by a flame formed with a fuel in any kinds of forms and a silicon compound that is introduced to the flame or added to the fuel in advance.

In order to make the flame, fuels in form of solid, liquid or gas may be used. A gaseous fuel is preferable because of its compatibility with the silicon containing compound and ease of use. Also, the gaseous fuel, such as propane, butane, natural gas or the like, can be used as a carrier gas of the silicon containing compound mentioned above.

In the flame, the silicon containing compound is decomposed then oxidized to form a super fine silica particle having an OH group on its surface. The silica particle is fixed on the surface of the substrate. In this way, the substrate surface is modified.

The silicon containing compound is preferably has a boiling points ranging from 0° C. to 300° C., more preferably 20° C. to 200° C. A silicon containing compound having a boiling point more than 300° C. has difficulty in evaporation, so that the concentration of the silicon containing compound in a gas mixture introduced to a flame may be not be kept constant.

The silicon containing compound is not limited to a special one. However, alkylsilanes and alkoxysilanes are preferable because they are commercially available.

Preferable examples of the silicon containing compounds includes tetraalkylsilane such as tetramethylsilane, tetraethylsilane, tetrapropylsilane, tetrabutylsilane, trimethylethylsilane, trimethylpropylsilane, and dimethyldiethylsilane, trialkylsilane such as trimethylsilane, triethylsilane, tripropylsilane, tributylsilane, dimethylethylsilane, and diethylmethylsilane, trialkylalkoxysilane such as trimethylmethoxysilane, trimethylethoxysilane, trimethylpropyoxysilane, trimethylbutoxysilane, triethylmethoxysilane, triethylethoxysilane, triethylpropyoxysilane, triethylbutoxysilane, dialkyldialkoxysilane such as dimethyldimethoxysilane, dimethyldiethoxysilane, dimethyldipropyoxysilane, dimethyldibutoxysilane, diethyldimethoxysilane, diethyldiethoxysilane, diethyldipropyoxysilane, diethyldibutoxysilane, alkyltrialkoxysilane such as methyltrimethoxysilane, methyltriethoxysilane, methyltripropyoxysilane, methyltributoxysilane, ethyltrimethoxysilane, ethyltriethoxysilane, ethyltripropyoxysilane, ethyltributoxysilane, tetraalkoxysilane such as tetramethoxysilane, tetraethoxysilane, tetrapropyloxysilane, tetrabutoxysilane, trimethoxyethoxysilane, trimethoxypropyoxysilane, and dimethoxydiethoxysilane, trialkoxysilane such as trimethoxysilane, triethoxysilane, tripropyoxysilane, tributoxysilane, dimethoxyethoxysilane, and diethoxymethoxysilane.

A silicon containing compound having Nitrogen atom, Halogen atom, vinyl group or amino group is also preferable. A silicon containing compound having Nitrogen atom such as hexamethyldisilazane, Halogen atom such as methyltrichlorosilane and dimethyldichloroslane, vinyl group such as vinyltrimethoxysilane and vinyltriethoxysilane or amino group such as 3-aminopropyltrimethoxysilane and 3-aminopropyltriethoxysilane is also preferable.

The concentration of the silicon containing compound in the fuel gas, liquid or solid is not limited to a special value, however, according to our experiments, between 0.001 ppm to 1000 ppm by weight of a fuel material is sufficient to obtain good result.

In the case that a silicon containing compound is highly flammable, the silicon containing compound may be mixed more in a fuel and may give better result. The silicon containing compound is preferably added into the flame directly or into a fuel or air or oxygen to form the flame in advance. In case of mixing with air in advance, resultant flame is easily controlled in its character by changing the mixing ratio of the silicon containing compound so that it is preferable.

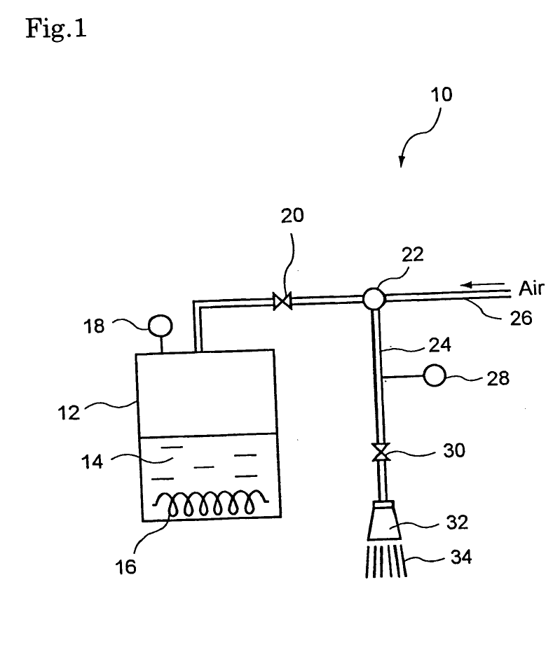

An example of the surface modification device 10, used in process (2), is shown in FIG. 1.

The surface modification device 10 is composed of a burner 32, storage tanks 28,12 for propane gas (fuel gas) and hexamethyldisilazane 14 (silicon containing compound), compressor (not shown) for air, mixing room 22 for mixing carrier gas (air) and hexamethyldisilazane 14, heater 16 and controller of the heater 16, pips 24,26, and sensors 18. The heater 16 heats the silicon containing compound 14 stored in the storage tank 12. A CPU (Central processor unit) controls the heater 16. The CPU is electrically connected to sensors 18 such as liquid volume sensor 18 for the silicon containing compound 14, temperature sensor for the silicon containing compound 14, temperature sensor for the burner 32, or the like. The silicon containing compound 14 is controlled by the sensors in its temperature and volume within a determined temperature and volume range. A vaporizing room, which is corresponding to an upper area of the tank 12, is filled with the vapor of the silicon containing compound 14 at about a saturated vapor pressure.

The device 10 is designed for the silicon containing compound 14 to be carried with the carrier gas (air) by opening a shutter 20, which is placed at the middle of the pipe connecting to the opening of the vaporizing room with the mixing room 22, when a flame 34 containing the silicon containing compound is required by an operator. The mixed gas of air and the vapor of the silicon containing compound 14 flows in the pipe 24 and further mixed with the fuel gas (propane gas) from the fuel storage tank 28. The resultant gas flows to the burner 32 through the pipes then burned to form flame 32.

By using this device 10, the surface modification is carried out. The surface modification improves the hydrophilicity of the substrate, for example, surface tension of a polypropylene is typically increased to 73 dyn/cm² or more.

This surface modification is preferably carried out for a period from 0.01 sec to 100 sec, more preferably 0.01 sec to 10 sec for an area of 100 cm². If the surface modification is carried out shorter than 0.01 sec, hydrophilicity obtained after the modification may be insufficient. If the surface modification is carried out longer than 100 sec, the substrate may be damaged by excessive heating.

(3) Undercoating.

After this surface modification, undercoating is carried out onto the modified surface of the substrate. Undercoating layer formed by the undercoating provides surface improved in leveling, absorption of a catalyst necessary for starting a silver mirror reaction and adhesiveness to a silver mirror layer.

The undercoating layer is usually formed by coating with a lacquer. The method of the coating is not limited to a special method so that includes spraying, roller coating, curtain coating, screen printing, and dipping.

The undercoating layer is not specially limited in thickness, however undercoating having thickness of 10 μm to 100 μm is preferable in the view point of prevention of a coating run of the lacquer or peeling of the resultant layer and cost-efficiency of the coating.

The lacquer used to form the undercoating layer is not limited to a special one, so that a heat-curable lacquer, UV-curable lacquer and so on are possible to use.

The lacquer for the undercoating contains a reactive resin, prepolymer, monomer, unreactive resin, filler, initiator, pigment, coupling agent, curing agent, deformer, surface activator, leveling agent, another additive, or the like.

An UV-curable lacquer is more preferable for the undercoating of the present invention because of its high productivity and resistance to an organic solvent. The resistance to an organic solvent of an undercoating layer enables to adopt various kinds of lacquer as topcoating lacquer.

An example of the reactive resin or prepolymer for an UV-curable lacquer for the undercoating include various kinds of acrylates, methacrylates, vinylpirolidones, maleimides, epoxides, oxcetanes, tetrahydrofurans, cyclopropanes, cyclobutans, and spirocyclic compounds. An acrylate or methacrylate is preferably used for an UV-curable lacquer for the undercoating because of their higher reactivity and ease of availability in the market. An example of the (meth)acrylates includes an epoxy(meth)acrylate, urethan(meth)acrylate, and ester(meth)acrylate.

An initiator being already widely known may be used for the lacquer for the undercoating of the present invention.

(4) Metal Layer Formation.

A metal layer is formed on the undercoting layer. The metal layer of the present invention is formed by reducing a metal cation with a reducing agent on the surface of the undercoating.

The method of forming the metal layer is composed of (4-1) applying (preferably spraying) catalyst solution on the surface of the undercoating; (4-2) washing the surface with water; (4-3) applying (preferably spraying) a solution containing a metal cation (preferably Ag⁺) and a solution containing a reducing agent at same time to form a metal layer on the undercoating layer or applying (preferably spraying) a solution obtained just after mixing a solution containing a metal cation (preferably Ag⁺) and a solution containing a reducing agent; and (4-4) washing the surface with water.

Process (4-1) is required to start the reducing reaction smoothly and evenly on the whole area of the undercoating surface. A conventionally-known chemical including Tin(II) compounds such as Tin(II) chloride(SnCl₂), Tin(II) acetate and the combination of Tin(II) compound and palladium ion containing compound may be used as the catalyst.

In order to improve wettability towards the undercoating surface, a surface-active agent is preferably added in the catalyst solution.

The method of applying the catalyst solution includes spraying, dipping, curtain coating and docter blade coating. The concentration of the chemicals in a catalyst solution depends on the method of applying.

When applying by spraying, for example, the concentration of Tin(II) chloride is preferably 0.1M-0.0001M.

In process (4-2), chloride ion and the excess of the surface-active agent must be removed almost completely. A remaining chloride ion may cause a white deposit on a resultant metal layer that will be formed in the following processes. If the surface-active agent remains, the resultant metal layer may be insufficient in adhesion to the undercoating.

The metal layer is formed in process (4-3). A metal ion containing solution such as Tolence agent is used when the metal is silver. In case of forming Cu layer as the metal layer of the present invention, a solution containing Cu(NO₃)₂ can be used as a metal ion containing solution.

Reductive agent in the reducing solution includes glucose, formaldehyde, hydrazine, hydrazine derivatives, sodium borohydrate, L-ascorbic acid and a salt thereof, and a sulfite salt, formic acid and a salt thereof, and tartaric acid. The combination of different kinds of reductive agents may offer better result. In case of the combination of formaldehyde and glucose, for example, reduction of a metal ion may be smoothly started by formaldehyde and then glucose provides stable reduction.

This metal layer is preferably 0.01 μm to 10 μm in thickness. If a metal layer is thinner than 0.01 μm, the metal layer may have poor reflectivity. Moreover, a solvent that is used for a lacquer for a topcoating may attack the undercoating layer though the excessively thin metal layer.

If a metal layer is thicker than 10 μm, the metal layer may have a tendency of lack of adhesiveness to the undercoating. Moreover, time required for formation of such a thick metal layer may reduce the productivity.

A metal forming the metal layer is not limited to a special one. The metal includes Ni, Cu, Ag, Pt, and Au. Silver is the most preferable because of its high reflective index and the excellent conductivity.

The concentration of the metal ion in the metal ion containing solution and the reductive agent in the reducing solution is determined in consideration of the reactivity between the metal ion and the reductive agent. A person in the art may be able to determine their concentrations to undergo the reaction practically only on the surface of the undercoating layer.

The metal ion and the reductive agents are preferably reacted at the temperature of 0° C. to 80° C. in the process (4-3). If they are reacted below 0° C., they may not react with each other effectively so that the efficiency of the use of the agents in each solution may be lowered, resulting in high production cost. If they are reacted above 80° C., a metal layer of insufficient in appearance may be obtained because of an oxidation of the metal layer by air.

(5) Topcoating

A topcoating layer is preferably formed on the metal layer of the present invention. The topcoating layer is usually formed by coating a lacquer. The method of the coating is not limited to a special method so that includes spraying, roller coating, curtain coating, screen printing, and dipping.

The topcoating is not specially limited in thickness, however a topcoating having thickness of 10 μm to 100 μm is preferable in the view point of prevention of a coating run of the lacquer or peeling of the resultant layer and cost-efficiency of the coating.

The lacquer used to form the topcoating layer is not limited to a special one, so that both heat-curable lacquer and UV-curable lacquer are possible to use and UV-curable lacquer is more preferable because of its hardness and productivity. The hardness of the topcoating layer is important in order to make design of a product be kept longer.

According to the present invention, goods for various applications that having a metal-like appearance can be obtained. Moreover, the goods can be used as a part of electrical device such as mobile phone, computer, TV and so on. An example of the goods includes antenna, shield for an electromagnetic wave, and electrical circuit.

### EXAMPLE

### Example 1

A Polypropylene (PP) plate (150 mm×75 mm×2 mm) was used as a substrate. The surface modification to the PP plate was carried out by ITRO treatment machine, which is available from ISIMAT-JAPAN.Ltd, using propane as a fuel gas and hexamethyldisilazane as a silicone containing compound for 1 second. The modified surface was turned to be hydrophilic surface with 73 dyn/cm² or more.

An undercoating layer with 10 μm in thickness was formed on the modified surface by spraying an UV-curable lacquer PES-B (available from ISIMAT-JAPAN. Ltd.), heating in an oven at 70° C. for 5 min and irradiating an UV light of 1000 mJ/cm².

A catalyst solution was prepared from 0.01M of HCl aq, 0.01M of SnCl₂, 0.01M of SnCl₄, 0.0001M of PdCl₂, 0.1% of SDS. The catalyst solution was sprayed to the undercoating until the surface of the undercoating layer was fully covered with the solution, then the surface was washed with water sprayed at 4 g/sec for 20 sec.

A metal ion containing solution containing [Ag(NH₃)₂]NO₃ and a reductive solution containing formaldehyde and glucose were sprayed to the washed surface at same time. The ratio of the volume of these two solutions had been kept around 1 during the spraying. A metal layer was formed within 10 seconds.

The metal layer was washed with water. The water, used for the washing, was removed completely by air-spraying.

This metal layer showed good adhesion with the substrate, that is, no peeling can be seen in a cross-cutting test (JIS K-5400) as mentioned later.

A topcoating was carried out to the metal layer by spraying an UV-lacquer (PES-B), heating in an oven at 70° C. for 5 min and irradiating UV light.

Evaluation of Adhesion

Cross-cutting test (JIS K-5400) was carried out for the resultant plate after the topcoating process according to the following criteria. The result was shown in Table 1.

VG (Very Good): No peeling was observed.

G (Good): one or two peelings were observed among 100 areas.

P (Poor): 3 to 10 peelings were observed among 100 areas.

VP (Very Poor): 11 or more peelings were observed among 100 areas.

### Examples 2-6

In Examples 2 to 6, the other substrates for Example 1, that is, ABS in Example 2, Polycarbonate in Example 3, Glass in Example 4, Aluminum in Example 5 and SUS in Example 6 were coated with undercoating layer, metal layer and topcoating layer by the same way as Example 1. These samples are evaluated for adhesion by the cross-cutting test, and the results were also shown in Table 1.

### Comparative Examples 1-6

Polypropylene, ABS, Polycarbonate, Glass, Aluminum or SUS was subjected to an undercoating without the surface modification by the silicon containing compound then formation of metal layer and topcoating in Comparative Examples 1 to 6. The resultant samples were evaluated for adhesion by the cross-cutting test, and the results were also shown in Table 1.

TABLE 1

| | Substrate | Cross-cutting test |
|---|---|---|
| Example 1 | PP | G |
| Example 2 | ABS | VG |
| Example 3 | PC | VG |
| Example 4 | Glass | G |
| Example 5 | Aluminum | G |
| Example 6 | SUS | G |
| Comparative Example 1 | PP | VP |
| Comparative Example 2 | ABS | P |
| Comparative Example 3 | PC | P |
| Comparative Example 4 | Glass | VP |
| Comparative Example 5 | Aluminum | VP |
| Comparative Example 6 | SUS | VP |

### INDUSTRIAL APPLICABILITY

According to the present invention, blowing a flame formed with a fuel and a silicon containing compound to the substrate (SURFACE MODIFICATION) before forming an undercoating layer by coating a lacquer (UNDERCOATING) enables to provide an undercoating suitable to be coated with a metal layer so that it is possible to provide a goods having a metal layer with good adhesion to a substrate, showing metal-like appearance. The present invention makes it possible to coat various substrates with the metal layer (silver mirror). Practically all kinds of substrate may be used as a substrate to be coated.

1. A method of producing a laminate body having a thin metal layer on a substrate including processes (1) to (4) as follows:
(1) preparing the substrate;
(2) blowing a flame in which a silicon containing compound is introduced;
(3) forming an undercoating layer by coating with a lacquer or a primer; and
(4) forming a thin metal layer by reducing a metal ion.

2. The method of producing a laminate body having a thin metal layer according to claim 1, wherein said thin metal layer is 0.01 μm to 10 μm in thickness.

3. The method of producing a laminate body having a thin metal layer according to claim 1, wherein the thin metal layer contains any one of metals selected from a group of Au, Ag, Cu, Ni and Al as a main element.

4. The method of producing a laminate body having a thin metal layer according to claim 1, wherein the flame is blown for a period from 0.1 to 100 seconds per 100 cm².

5. The method of producing a laminate body having a thin metal layer according to claim 1, wherein a topcoating layer is formed by coating with a lacquer on said thin metal layer.

6. The method of producing a laminate body having a thin metal layer according to claim 1, wherein the lacquer for the undercoating is an UV-curable lacquer.

7. The method of producing a laminate body having a thin metal layer according to claim 5, wherein the lacquer for the topcoating is an UV-curable lacquer.

8. The method of producing a laminate body having a thin metal layer according to claim 1, wherein the said thin metal layer is formed as a part of amusements, electrical products, vehicles, instruments, tools, furniture, or ornaments.
